(19) United States
(12) Patent Application Publication
(10) Pub. No.: US 2020/0214311 A1
(43) Pub. Date: Jul. 9, 2020

(54) ROLL-IN OIL AND FAT COMPOSITION

(71) Applicant: FUJI OIL HOLDINGS INC., Osaka (JP)

(72) Inventors: Mikio NAKANO, Ibaraki (JP); Yoshitomo FUKAHORI, Ibaraki (JP); Junichi SAKATA, Ibaraki (JP); Kyoko TSUBURAYA, Ibaraki (JP); Yuta SUZUKI, Ibaraki (JP)

(73) Assignee: FUJI OIL HOLDINGS INC., Osaka (JP)

(21) Appl. No.: 16/638,471

(22) PCT Filed: Aug. 3, 2018
(86) PCT No.: PCT/JP2018/029253

§ 371 Date: Feb. 12, 2020

(30) Foreign Application Priority Data
Sep. 14, 2017 (JP) 2017-176328

(51) Int. Cl. A23D 7/005; A21D 2/16; A21D 2/14

(52) U.S. Cl. CPC A23D 7/0053; A21D 2/145; A21D 2/16

(57) ABSTRACT

A roll-in oil and fat composition is prepared, in which 45 to 95% by weight of transesterified oils and fats, 5 to 25% by weight of a liquid oil, and less than 1% by weight of high-melting point oils and fats are contained in an oily phase, wherein the transesterified oils and fats have a lauric acid content of 5 to 25% by weight, a palmitic acid content of 5 to 25% by weight, and a stearic acid content of 10 to 35% by weight all relative to the total content of all of constituent fatty acids and have a stearic acid-to-palmitic acid weight ratio of 0.5 to 7, and the high-melting point oils and fats have an open-tubed melting point of higher than 45° C. Layered bakery food is produced using the roll-in oil and fat composition.

### TECHNICAL FIELD

The present invention relates to a roll-in oil and fat composition having excellent spreadability in a wide temperature range and layered bakery food which is produced using the roll-in oil and fat composition and has a juicy texture and a good crispy texture.

### BACKGROUND ART

In a case of producing layered bakery foods such as pies or Danish pastries, a roll-in oil and fat composition is folded into dough in a layer shape in order to form a layered structure. Thereafter, the layered dough is baked to produce layered bakery food having good unique crispiness and a crunchy feeling. Such a roll-in oil and fat composition is required to have spreadability in a wide temperature range of, for example, 5° C. to 25° C., when being folded into dough and have excellent crispiness and a melt-in-the-mouth feeling after being baked.

In response to the above-described requirements, a roll-in oil and fat composition that has spreadability and excellent crispiness and a melt-in-the-mouth feeling after being baked has been obtained in the related art by formulating hydrogenated oils of animal and vegetable oils and fats as high-melting-point oils and fats or medium-melting-point oils and fats with a roll-in oil and fat composition together with liquid oils and fats.

In recent years, the adverse effects of trans fatty acids in oils and fats which are derived from hydrogenated oils on health have been seen as a problem. Therefore, there has been a growing demand for a low-trans-type roll-in oil and fat composition in which fractionated oils or transesterified oils of animal and vegetable oils and fats are used as a base instead of hydrogenated oils, and there is demand for plastic oils and fats which are of the low-trans type and have spreadability and excellent crispiness and a melt-in-the-mouth feeling after baking and a roll-in oil and fat composition using plastic oils and fats.

In addition, layered bakery foods such as croissants, pies, and Danish pastries have become popular in oven fresh bakeries, which are so-called bakeries in towns that sell fresh-baked bread, and have become symbols of bakery stores. It can be said that consumers prefer the juicy texture and the good crispy texture of fresh-baked bread. On the other hand, although convenience stores, mass merchandisers, and the like also sell croissants, pies, and Danish pastries, it is may not be difficult to sell fresh-baked bread due to a problem such as a long delivery time. Therefore, there is a strong demand for technology that can maintain the juicy texture and good crispy texture for a long period of time.

A roll-in oil and fat composition is usually used in a case of producing layered bakery foods such as croissants, pies, and Danish pastries, and plays an important role as the shape and the flavor of the layered bakery foods are determined by the oil and fat composition used. In many cases, products are produced manually in oven fresh bakeries. Dough is kneaded, and a roll-in oil and fat composition is folded into the dough which is then fermented in a dryer and baked in an oven. Since the work is mainly manual operations, it is possible to perform a folding operation by appropriately adjusting the temperature according to physical properties of an oil and fat composition to be used or by appropriately adjusting the fermentation time in a final proofer, the temperature management, and the like. It is possible to appropriately perform a folding operation even in a case where an oil and fat composition, for example, is butter, whose hardness changes greatly according to the temperature is used and to perform fermentation in a final proofer for a long period of time at around 30° C. at which butter does not melt. Therefore, it can be said that there need not be many cases limiting the quality of the oil and fat composition.

On the other hand, in a case where products are sold at convenience stores, mass merchandisers, and the like, the products are mass-produced as a matter of course. For this reason, the products are produced by facilities such as continuous lines. In the present situation, the folding operation is performed automatically, and the fermentation is performed in a final proofer at about 36° C. to 40° C. in order to increase the efficiency. For this reason, it is desirable that the roll-in oil and fat composition have a quality so that there is little change in the hardness of the composition in a wide temperature range and the composition has excellent spreadability and does not melt in a final proofer. Therefore, it is difficult to practically use an oil and fat composition, such as butter, which has a narrow working temperature range.

In order to overcome such a problem, a method for formulating high-melting-point fats with an oily phase of a roll-in oil and fat composition so that there is little change in the hardness of the composition in a wide temperature range and the composition has excellent spreadability and does not melt in a final proofer is generally known. However, there is a problem in that croissants, pies, and Danish pastries which can be produced through this method lack a juicy feeling. Fresh-baked bread sold at oven fresh bakeries is sold in a state in which oils and fats melted in a baking step are rarely solidified. Therefore, the liquid-like oils and fats spread in the mouth, thereby providing a juicy feeling. On the other hand, the oils and fats may easily solidify since it takes time for delivery or the like in the cases of convenience stores and mass merchandisers. In addition, the solidification is further accelerated by formulating high-melting-point fats with the composition as described above. Therefore, it is difficult to obtain a juicy feeling.

In order to cope with the above-described problems, Patent Literature 1 or 2 has been disclosed as a method that enables provision of layered bakery foods having a juicy feeling even if the layered bakery foods are produced in facilities such as continuous lines and it takes time for delivery.

Patent Literature 1 relates to a water-in-oil type emulsion composition for rolling-in which contains respective specific amounts of fat derived from milk, oils and fats in a liquid state at 20° C., and palm hardened oils and has an effect of enhancing a juicy feeling of the fat derived from milk. Patent Literature 2 relates to a water-in-oil type emulsion composition for rolling-in which contains a crystal regulator selected from specific emulsifiers, and with which a juicy feeling is imparted to layered bakery foods by delaying solidification of oils and fats in the layered bakery foods after being baked through the effect of the crystal regulator.

The methods of Patent Literature 1 and 2 are effective methods for imparting a juicy feeling. However, the methods are inventions using hardened oils containing trans fatty acids, and therefore, there is also a disclosure of a low-trans type roll-in oil and fat composition that imparts a juicy feeling.

Patent Literature 3 discloses an emulsified oil and fat composition for rolling-in which contains 25 to 55% by weight of a liquid oil and 6 to 33% by weight of 2-oleo-1,3-distearin (SOS) in an oily phase, but contains substantially no trans fatty acids, and in which a lauric acid content of constituent fatty acids of the oily phase is less than or equal to 7% by weight. It is disclosed that the oil and fat composition has favorable spreadability and imparts a juicy texture in baked croissants. However, there are problems in that raw oils and fats of SOS are relatively expensive and production becomes complicated since a fractionation step is required. In addition, although an excellent juicy texture can be obtained in the method, there is a tendency for the spreadability of the emulsified oil and fat composition for rolling-in to deteriorate.

Patent Literature 4 discloses a plastic oil and fat composition that can provide bakery products, particularly layered bakery products which have a juicy feeling without tackiness, and in which there is little change in texture with time. The plastic oil and fat composition has a specific triglyceride composition due to a combination of lard, a palm medium-melting-point portion, extremely hardened oils, liquid oils, and the like. A juicy feeling is intended which is a texture felt when oils and fats ooze from the bakery foods when biting the bakery foods with the teeth even through there is no oily feeling at the moment when the products are put into the mouth. There is a tendency that a juicy feeling cannot be sufficiently obtained by using high-melting-point oils and fats.

Patent Literature 5 relates to an oil and fat composition for a layered food which has a specific triglyceride composition and contains a milk fat-fractionated low-melting-point portion, transesterified oils including an oil mixture of lauric oils and fats and palm oils and fats, transesterified oils including palm oils and fats, and liquid oils. A juicy texture derived from milk fat is exhibited by formulating a milk fat-fractionated low-melting-point portion with vegetable oils and fats having a relatively good melt-in-the-mouth feeling. However, there are problems in that the milk fat-fractionated low-melting-point portion is relatively expensive and production becomes complicated since a fractionation step is required. In addition, the juicy feeling according to the present invention is also a texture felt when oils and fats ooze from bakery foods when biting the bakery foods with the teeth even though there is no oily feeling at the moment when the bakery foods are put into the mouth, and is therefore different from a juicy feeling of fresh-baked layered bakery products. Furthermore, since the palm oils and fats are main components, the chewy texture of the oil and fat composition for a layered food tends to become slightly low.

### CITATION LIST

### Patent Literature

Patent Literature 1: Japanese Re-Publication of PCT Application No. 2006/11331

Patent Literature 2: Japanese Patent Laid-Open No. 2012-183080

Patent Literature 3: Japanese Re-Publication of PCT Application No. 2007/153902

Patent Literature 4: Japanese Patent Laid-Open No. 2013-188205

Patent Literature 5: Japanese Patent Laid-Open No. 2016-82887

### SUMMARY OF INVENTION

### Technical Problem

The present invention addresses the problem of providing: a roll-in oil and fat composition which is of a low-trans type with a trans fatty acid content of less than 5% by weight, has a high chewy texture, has excellent spreadability in a wide temperature range, and has an excellent melt-in-the-mouth feeling; and layered bakery food which can be produced using the roll-in oil and fat composition and has substantially a fresh-baked juicy texture and crispiness even one day after being baked.

### Solution to Problem

As described above, in the methods proposed in the related art, it is impossible to obtain a low-trans type roll-in oil and fat composition which has all of the characteristics of strength of a chewy texture during preparation of layered bakery dough of a roll-in oil and fat composition, spreadability in a wide temperature range, and substantially a fresh-baked juicy texture even one day after being baked.

The present inventors have conducted extensive studies on roll-in oil and fat compositions in order to solve the above-described problems. As a result, they have found that a roll-in oil and fat composition, which includes specific proportions of liquid oils and random transesterified oils including specific proportions of lauric acid, palmitic acid, and stearic acid in the total constituent fatty acid composition, has an excellent chewy texture and spreadability, and that the roll-in oil and fat composition and a layered bakery baked using the roll-in oil and fat composition have substantially a fresh-baked juicy texture and excellent crispiness even one day after being baked, and have completed the present invention.

That is, the present invention relates to the following.

(1) A roll-in oil and fat composition including: 45 to 95% by weight of transesterified oils and fats, 5 to 25% by weight of a liquid oil, and less than 1% by weight of high-melting-point oils and fats in an oily phase, in which the transesterified oils and fats have a lauric acid content of 5 to 25% by weight, a palmitic acid content of 5 to 25% by weight, and a stearic acid content of 10 to 35% by weight all relative to the total content of all of constituent fatty acids and have a stearic acid-to-palmitic acid weight ratio of 0.5 to 7, and the high-melting-point oils and fats have a rising melting point of higher than 45° C.

(2) The roll-in oil and fat composition according to (1), in which the high-melting-point oils and fats having a rising melting point of higher than 45° C. are not contained in the oily phase.

(3) The roll-in oil and fat composition according to (1), in which the oils and fats in the oily phase have a rising melting point of 30° C. to 40° C., and an SFC(Solid Fat Content, SFC) of 20% to 45% at 20° C., and an SFC of less than or equal to 10% at 35° C.

(4) The roll-in oil and fat composition according to (2), in which the oils and fats in the oily phase have a rising melting point of 30° C. to 40° C., an SFC of 20% to 45% at 20° C., and an SFC of less than or equal to 10% at 35° C.

(5) The roll-in oil and fat composition according to (1), in which a fat and oil content is 50 to 100% by weight.

(6) The roll-in oil and fat composition according to (2), in which a fat and oil content is 50 to 100% by weight.

(7) The roll-in oil and fat composition according to (3), in which a fat and oil content is 50 to 100% by weight.

(8) The roll-in oil and fat composition according to (4), in which the fat and oil content is 50 to 100% by weight.

(9) Layered bakery food using the roll-in oil and fat composition according to (5).

(10) Layered bakery food using the roll-in oil and fat composition according to (6).

(11) Layered bakery food using the roll-in oil and fat composition according to (7).

(12) Layered bakery food using the roll-in oil and fat composition according to (8).

### Advantageous Effects of Invention

According to the present invention, it is possible to provide: a roll-in oil and fat composition which is of a low-trans type with a trans fatty acid content of less than 5% by weight, has a high chewy texture, has excellent spreadability in a wide temperature range, and has an excellent melt-in-the-mouth feeling; and layered bakery food which can be produced using the roll-in oil and fat composition and has substantially a fresh-baked juicy texture and crispiness even one day after being baked.

### DESCRIPTION OF EMBODIMENTS

A roll-in oil and fat composition of the present invention includes: 45 to 95% by weight, more preferably 50 to 90% by weight, of transesterified oils and fats, 5 to 25% by weight, more preferably 10 to 25% by weight, of a liquid oil, and less than 1% by weight of high-melting-point oils and fats in an oily phase, in which the transesterified oils and fats have a lauric acid content of 5 to 25% by weight, a palmitic acid content of 5 to 25% by weight, and a stearic acid content of 10 to 35% by weight all relative to the total content of all of constituent fatty acids and have a stearic acid-to-palmitic acid weight ratio of 0.5 to 7, and the high-melting-point oils and fats have a rising melting point of higher than 45° C.

In a case where the content of the transesterified oils and fats is less than 45% by weight, the chewy texture of the roll-in oil and fat composition tends to become low. On the other hand, in a case where the content thereof exceeds 95% by weight, a juicy feeling of layered bakery food produced using the roll-in oil and fat composition one day after being baked tends to decrease. In a case where the content of the liquid oils is less than 5% by weight, the juicy feeling of layered bakery food produced using the roll-in oil and fat composition one day after being baked similarly tends to decrease. In addition, in a case where the content of the liquid oils exceeds 25% by weight, the chewy texture of the roll-in oil and fat composition tends to become low. In the present invention, it is desirable that the content of high-melting-point oils and fats which are generally formulated with the oily phase of the roll-in oil and fat composition and have a rising melting point of higher than 45° C. be less than 1% by weight, and it is more preferable that no high-melting-point oils and fats be contained therein at all. In a case where such high-melting-point oils and fats are formulated therewith, there is a tendency that the melt-in-the-mouth feeling of the roll-in oil and fat composition decreases and imparting of a juicy feeling to the layered bakery food produced using the roll-in oil and fat composition one day after being baked is also inhibited.

The lauric acid content in the transesterified oils and fats is more preferably 10 to 20% by weight, and the palmitic acid content is more preferably 5 to 20% by weight. In addition, the stearic acid content is more preferably 15 to 35% by weight. The St/P ratio is more preferably 0.8 to 5 and most preferably 1 to 3.

In a case where the above-described lauric acid content is less than 5% by weight, the melt-in-the-mouth feeling of the roll-in oil and fat composition tends to decrease and the melt-in-the-mouth feeling of a layered bakery as a final product also tends to become heavy. On the other hand, in a case where the lauric acid content exceeds 25% by weight, the roll-in oil and fat composition tends to become hard at low temperature, and there is a tendency that the chewy texture of the roll-in oil and fat composition becomes low and the spreadability in a wide temperature range of, for example, 5° C. to 25° C., deteriorates, which is not preferable.

In a case where the above-described palmitic acid content is less than 5% by weight, the melt-in-the-mouth feeling of the roll-in oil and fat composition tends to decrease as expected and the melt-in-the-mouth feeling of a layered bakery as a final product also tends to become heavy. On the other hand, in a case where the palmitic acid content exceeds 25% by weight, the roll-in oil and fat composition tends to become slightly hard at low temperature, and there is a tendency that the chewy texture of the roll-in oil and fat composition becomes low and the spreadability in a wide temperature range of, for example, 5° C. to 25° C., deteriorates.

In a case where the above-described stearic acid content is less than 10% by weight, the melt-in-the-mouth feeling of the roll-in oil and fat composition tends to improve. However, the roll-in oil and fat composition tends to become hard at low temperature, the chewy texture of the roll-in oil and fat composition becomes low, and the spreadability in a wide temperature range of, for example, 5° C. to 25° C., deteriorates, which is not preferable. On the other hand, in a case where the stearic acid content exceeds 35% by weight, the melt-in-the-mouth feeling of the roll-in oil and fat composition tends to decrease as expected and the melt-in-the-mouth feeling of a layered bakery as a final product also tends to become heavy.

In a case where the above-described stearic acid-to-palmitic acid weight ratio is less than 0.5, the melt-in-the-mouth feeling of the roll-in oil and fat composition tends to improve. However, the roll-in oil and fat composition tends to become hard at low temperature, the chewy texture of the roll-in oil and fat composition becomes low, and the spreadability in a wide temperature range of, for example, 5° C. to 25° C., deteriorates, which is not preferable. On the other hand, in a case where the stearic acid-to-palmitic acid weight ratio exceeds 7, the melt-in-the-mouth feeling of the roll-in oil and fat composition tends to decrease as expected and the melt-in-the-mouth feeling of a layered bakery as a final product also tends to become heavy.

The liquid oils used in the roll-in oil and fat composition of the present invention are not particularly limited as long as these are oils and fats exhibiting a liquid state at temperatures between refrigeration temperature and room temperature, and one kind or two or more kinds selected from rapeseed oil, soybean oil, corn oil, sunflower oil, rice bran oil, cottonseed oil, safflower oil, palm super olein, and the like can be used.

It is preferable that in the roll-in oil and fat composition of the present invention be less than 1% by weight or that no high-melting-point oils and fats be contained therein at all. The high-melting-point oils and fats having a rising melting point of higher than 45° C. are one kind or two or more kinds of oils and fats which have a rising melting point of higher than 45° C. and are selected from various vegetable oils and fats and animal oils and fats such as lauric oils and fats, palm oils and fats, corn oil, cottonseed oil, soybean oil, rapeseed oil, rice oil, sunflower oil, safflower oil, beef tallow, milk fat, lard, cacao butter, fish oil, and whale oil, and fractionated oils, transesterified oils and fats, and hydrogenated oils and fats of these oils and fats.

The roll-in oil and fat composition of the present invention preferably has a rising melting point of 30° C. to 40° C., an SFC of 20% to 45% at 20° C., and an SFC of less than or equal to 10% at 35° C. The rising melting point is more preferably 32° C. to 38° C. In addition, the SFC is more preferably 25% to 40% at 20° C. and less than or equal to 9% at 35° C.

In a case where the rising melting point is lower than 30° C., the spreadability in a temperature range of 20° C. to 25° C. tends to deteriorate. In a case where the rising melting point is higher than 40° C., the melt-in-the-mouth feeling of the roll-in oil and fat composition tends to decrease and the melt-in-the-mouth feeling of a layered bakery as a final product also tends to become heavy. In addition, in a case where the SFC at 20° C. is less than 20%, the spreadability in a temperature range of 20° C. to 25° C. tends to deteriorate. In a case where the SFC at 20° C. exceeds 45%, the spreadability at a low temperature of 5° C. to 10° C. tends to deteriorate. In a case where the SFC at 35° C. exceeds 10%, the melt-in-the-mouth feeling of the roll-in oil and fat composition tends to decrease and the melt-in-the-mouth feeling of a layered bakery as a final product also tends to become heavy.

The transesterified oils and fats of the present invention can be obtained, for example, by being formulated with the following oil and fat raw materials and then performing transesterification. 10 to 50% by weight of lauric oils and fats as a lauric acid source, 0 to 75% by weight of palm oils and fats as a palmitic acid source, 10 to 30% by weight of extremely hardened oils of liquid oils and fats or natural fats and oils rich in stearic acid as a stearic acid source, and an appropriate amount of liquid oils and fats rich in unsaturated fatty acids or oils and fats rich in saturated fatty acids having 20 to 24 carbon atoms as necessary for adjusting the rising melting point and the SFC of the transesterified oils and fats may be mixed with each other and used for transesterification.

One kind or two or more kinds selected from coconut oil, palm kernel oil, and babassu oil, and fractionated oils, hydrogenated oils, and transesterified oils thereof can be used as the lauric oils and fats, and extremely hardened oils are preferable in the case of hydrogenated oils.

One kind or two or more kinds selected from palm oils and fractionated palm oils such as palm olein, super palm olein, a palm medium-melting-point portion, and palm stearin, and hydrogenated oils and transesterified oils thereof can be used as the palm oils and fats, and extremely hardened oils are preferable in the case of hydrogenated oils.

One kind or two or more kinds selected from extremely hardened oils of oils and fats, such as rapeseed oil, soybean oil, corn oil, sunflower oil, rice bran oil, cottonseed oil, and safflower oil, rich in unsaturated fatty acids having 18 carbon atoms can be used as the extremely hardened oils of liquid oils and fats. One kind or two or more kinds selected from shea butter, sal fat, kokum fat, mango fat, and Allanblackia fat, and fractionated oils, hydrogenated oils, and transesterified oils thereof can be used as the natural fats and oils rich in stearic acid, and extremely hardened oils are preferable in the case of hydrogenated oils.

One kind or two or more kinds selected from rapeseed oil, soybean oil, corn oil, sunflower oil, rice bran oil, cottonseed oil, and safflower oil can be used as the liquid oils and fats rich in unsaturated fatty acids. Examples of oils and fats rich in saturated fatty acids having 20 to 24 carbon atoms include extremely hardened oils of high-erucic acid rapeseed oil or fish oil.

The above-described transesterification reaction may be a reaction performed through a method using a chemical catalyst such as sodium methylate or a method using an enzyme such as lipase, or may be a non-selective randomization reaction or a selective transesterification reaction with position specificity, but is preferably a non-selective randomization reaction.

The oil and fat content of the roll-in oil and fat composition of the present invention is 50 to 100% by weight, more preferably 70 to 90% by weight, and most preferably 80 to 87% by weight. In a case where the oil and fat content is less than 50% by weight, there is a tendency that the chewy texture of the roll-in oil and fat composition of the present invention becomes low and the spreadability in a wide temperature range of, for example, 5° C. to 25° C., deteriorates.

It is possible to formulate medium-melting-point oils and fats at a melting point of 22° C. to 45° C., which are derived from one kind or two or more kinds of oils and fats selected from various vegetable oils and fats and animal oils and fats such as lauric oils and fats, palm oils and fats, corn oil, cottonseed oil, soybean oil, rapeseed oil, rice oil, sunflower oil, safflower oil, beef tallow, milk fat, lard, cacao butter, fish oil, and whale oil, and fractionated oils and transesterified oils and fats thereof, with the oily phase of the roll-in oil and fat composition of the present invention in addition to the above-described transesterified oils and fats and liquid oils within the range in which the strength of the chewy texture and the juicy feeling of layered bakery food produced using the roll-in oil and fat composition one day after being baked are not inhibited. In addition, milk fat or butter can be formulated therewith as medium-melting-point oils and fats. It is possible to obtain a juicy feeling with enhanced butter flavor by blending milk fat or butter therewith.

The roll-in oil and fat composition of the present invention may be of a margarine type containing an aqueous phase or a shortening type containing no aqueous phase, but is preferably of a margarine type containing an aqueous phase. The margarine type may be any of a water-in-oil type, an oil-in-water type, or a double emulsion type, but is preferably a water-in-oil type.

An emulsifier may be added to the roll-in oil and fat composition of the present invention as necessary. Examples of emulsifiers include lecithin, a glycerin fatty acid ester, a polyglycerol condensed ricinoleic acid ester, a sugar ester, a polyglycerol fatty acid ester, a sorbitan fatty acid ester, a polyoxyethylene sorbitan fatty acid ester, a propylene glycol fatty acid ester, various organic acid monoglycerides such as acetic acid monoglyceride, tartaric acid monoglyceride, acetic acid-tartaric acid mixed monoglyceride, citric acid monoglyceride, diacetyl tartaric acid monoglyceride, lactic acid monoglyceride, succinic acid monoglyceride, and malic acid monoglyceride, stearoyl calcium lactate, and stearoyl sodium lactate.

Oil-soluble components such as pigments, antioxidants, and flavorings and water-soluble components such as organic acids, table salt, sugars, powdered milk, and fermented milk can be used in the roll-in oil and fat composition of the present invention as desired in addition to the above-described oils and fats and additives.

Although the method for producing a roll-in oil and fat composition of the present invention is not particularly limited, a roll-in oil and fat composition can be produced by preliminarily emulsifying an oily phase and an aqueous phase according to a usual method and then rapidly cooling and kneading using a perfector, a votator, a combinator, and the like. An oily phase can be produced by adding oil-soluble components such as pigments, antioxidants, and flavorings to melted oils and fats as necessary and dissolving and dispersing the oil-soluble components therein. An aqueous phase can be produced by adding water-soluble milk components, and as necessary, table salt, sugars, inorganic salts, and the like to water or warm water and dissolving and dispersing the components therein.

The layered bakery food of the present invention can be produced by thinly rolling wheat flour dough obtained by adding water, salt, and the like to wheat flour as main raw materials and mixing them with each other, placing the roll-in oil and fat composition of the present invention on the wheat flour dough, folding the wheat flour dough, repeatedly thinly rolling the wheat flour dough again to make layered dough, and fermenting, molding, and baking the layered dough as necessary. Specific examples of layered bakery foods produced in this manner include Danish pastries, croissants, and pies. In particular, there is an advantage in the Danish pastries and croissants of the present invention that it is possible to maintain substantially a fresh-baked juicy texture and a good crispy texture even one day after standing at normal temperature of 15° C. to 25° C. after baking.

### EXAMPLES

Hereinafter, the present invention will be described in more detail by illustrating with examples. In the examples, both % and parts mean a weight basis unless otherwise specified. The fatty acid composition, the rising melting point, and the SFC of oils and fats are measured through the following methods.

Fatty acid composition: Measured according to a method defined in 2.4.1.2 Methyl Esterification Method (Boron Trifluoride-Methanol Method) of Standard Methods for the Analysis of Fats, Oils, and Related Materials (1996 Version) of Japan Oil Chemists' Society.

Rising melting point: Measured according to a method defined in 2.2.4.2 (Rising melting point) of Standard Methods for the Analysis of Fats, Oils, and Related Materials (1996 Version) of Japan Oil Chemists' Society.

SFC: Measured according to IUPAC.2 150 SOLID CONTENT DETERMINATION IN FATS BY NMR.

(Preparation of Transesterified Oils and Fats)

### Trial Production Example 1

44 parts of a palm oil-fractionated low-melting-point portion (iodine value of 67), 40 parts of a palm kernel oil-fractionated low-melting-point portion (iodine value of 26), and 16 parts of extremely hardened rapeseed oil (iodine value of 1.2) were mixed with each other and subjected to a random transesterification reaction using sodium methylate as a catalyst, and then, decolorization and deodorization were performed according to a usual method to obtain transesterified oils and fats 1 as a purified oil. The composition of the obtained oils and fats 1 is shown in Table 1.

### Trial Production Example 2

25 parts of a palm oil-fractionated low-melting-point portion (iodine value of 67), 40 parts of a palm kernel oil-fractionated low-melting-point portion (iodine value of 26), 23 parts of extremely hardened rapeseed oil (iodine value of 1.2), and 12 parts of rapeseed oil were mixed with each other and subjected to a random transesterification reaction using sodium methylate as a catalyst, and then, decolorization and deodorization were performed according to a usual method to obtain transesterified oils and fats 2 as a purified oil. The composition of the obtained oils and fats 2 is shown in Table 1.

### Trial Production Example 3

40 parts of a palm kernel oil-fractionated low-melting-point portion (iodine value of 26), 30 parts of extremely hardened rapeseed oil (iodine value of 1.2), and 30 parts of rapeseed oil were mixed with each other and subjected to a random transesterification reaction using sodium methylate as a catalyst, and then, decolorization and deodorization were performed according to a usual method to obtain transesterified oils and fats 3 as a purified oil. The composition of the obtained oils and fats 3 is shown in Table 1.

### Trial Production Example 4

50 parts of palm oils (iodine value of 52), 40 parts of a palm kernel oil-fractionated low-melting-point portion (iodine value of 26), and 10 parts of a palm-fractionated high-melting-point portion (iodine value of 42) were mixed with each other and subjected to a random transesterification reaction using sodium methylate as a catalyst, and then, decolorization and deodorization were performed according to a usual method to obtain a transesterified oils and fats 4 as a purified oil. The composition of the obtained oils and fats 4 is shown in Table 1.

### Trial Production Example 5

55 parts of palm oils (iodine value of 52), 40 parts of a palm kernel oil-fractionated low-melting-point portion (iodine value of 26), and 5 parts of extremely hardened rapeseed oil (iodine value of 1.2) were mixed with each other and subjected to a random transesterification reaction using sodium methylate as a catalyst, and then, decolorization and deodorization were performed according to a usual method to obtain transesterified oils and fats 5 as a purified oil. The composition of the obtained oils and fats 5 is shown in Table 1.

TABLE 1

| | Trial | Trial | Trial | Trial | Trial |
|---|---|---|---|---|---|
| | Production | Production | Production | Production | Production |
| | Example 1 | Example 2 | Example 3 | Example 4 | Example 5 |
| Transesterified | Oils and fats 1 | Oils and fats 2 | Oils and fats 3 | Oils and fats 4 | Oils and fats 5 |
| oils and fats | | | | | |
| Lauric acid | 17.6 | 15.6 | 15.7 | 15.5 | 15.4 |
| content % | | | | | |
| Palmitic acid | 20.9 | 13.3 | 5.9 | 33.2 | 28.9 |
| content % | | | | | |
| Stearic acid | 21.8 | 24.3 | 30.4 | 4.0 | 8.2 |
| content % | | | | | |
| St/P Ratio | 1.0 | 1.8 | 5.2 | 0.1 | 0.3 |
| Rising melting | 37.4 | 35.4 | 32.0 | 33.7 | 33.3 |
| point ° C. | | | | | |
| SFC at 20° C. | 46.4 | 31.7 | 32.1 | 29.7 | 27.2 |
| SFC at 35° C. | 8.5 | 4.0 | 4.9 | 2.4 | 1.9 |

St/P Ratio: Stearic acid-to-palmitic acid weight ratio

The following transesterified high-melting-point oils and fats was separately prepared for preparation of a roll-in oil and fat composition.

Trial Production Example 6 (Transesterified High-Melting-Point Oils and Fats)

An oil and fat mixture of 60 parts of a palm oil high-melting-point portion (iodine value of 40), 37 parts of palm oils (iodine value of 52), and 3 parts of extremely hardened high erucic acid rapeseed oil (iodine value of 1.0) was subjected to a random transesterification reaction using sodium methylate as a catalyst, and then, decolorization and deodorization were performed according to a usual method to obtain transesterified oils and fats 6 as a purified oil. The rising melting point of the oils and fats 6 was 46° C.

In addition, purified oils of extremely hardened high erucic acid rapeseed oil (iodine value of 1.0 and rising melting point of 62° C.) was prepared as high-melting-point oils and fats.

(Preparation of Roll-in Oil and Fat Composition)

### Example 1

Melted oils of 82 parts of the oils and fats 1 prepared in Trial Production Example 1 and 18 parts of rapeseed oil were mixed with each other, and 0.48 parts of stearic acid monoglyceride (trade name: Emulsy P100 manufactured by RIKEN VITAMIN CO., LTD.) and 0.12 of lecithin were added thereto to prepare an oily phase. 1.0 parts of table salt was added to 16 parts of water to prepare an aqueous phase. 83 parts of the oily phase and 17 parts of the aqueous phase were mixed with each other and stirred at 60° C. to be preliminarily emulsified, and rapidly cooled and kneaded with a combinator to obtain a roll-in oil and fat composition 1 having a favorable structure. The rising melting point of the oily phase was 36.0° C.

### Example 2

A roll-in oil and fat composition was prepared in the same manner as in Example 1 by replacing 82 parts of the oils and fats 1 in Example 1 with 82 parts of the oils and fats 2 prepared in Trial Production Example 2 to obtain a roll-in oil and fat composition 2. The rising melting point of the oily phase was 34.2° C.

### Example 3

A roll-in oil and fat composition was prepared in the same manner as in Example 1 by replacing 82 parts of the oils and fats 1 in Example 1 with 82 parts of the oils and fats 3 prepared in Trial Production Example 3 to obtain a roll-in oil and fat composition 3. The rising melting point of the oily phase was 31.2° C.

### Comparative Example 1

A roll-in oil and fat composition was prepared in the same manner as in Example 1 by replacing 82 parts of the oils and fats 1 in Example 1 with 82 parts of the oils and fats 4 prepared in Trial Production Example 4 to obtain a roll-in oil and fat composition 4. The rising melting point of the oily phase was 32.2° C.

### Comparative Example 2

A roll-in oil and fat composition was prepared in the same manner as in Example 1 by replacing 82 parts of the oils and fats 1 in Example 1 with 82 parts of the oils and fats 5 prepared in Trial Production Example 5 to obtain a roll-in oil and fat composition 5. The rising melting point of the oily phase was 32.1° C.

### Comparative Example 3

Melted oils of 70 parts of the oils and fats 1 prepared in Trial Production Example 1, 20 parts of the oils and fats 6 prepared in Trial Production Example 6, and 10 parts of rapeseed oil were mixed with each other, and 0.48 parts of stearic acid monoglyceride (trade name: Emulsy P100 manufactured by RIKEN VITAMIN CO., LTD.) and 0.12 of lecithin were added thereto to prepare an oily phase. 1.0 parts of table salt was added to 16 parts of water to prepare an aqueous phase. 83 parts of the oily phase and 17 parts of the aqueous phase were mixed with each other and stirred at 60° C. to be preliminarily emulsified, and rapidly cooled and kneaded with a combinator to obtain a roll-in oil and fat composition 6 having a favorable structure. The rising melting point of the oily phase was 37.3° C.

### Comparative Example 4

Melted oils of 80 parts of the oils and fats 1 prepared in Trial Production Example 1, 2 parts of extremely hardened high erucic acid rapeseed oil, and 18 parts of rapeseed oil were mixed with each other, and 0.48 parts of stearic acid monoglyceride (trade name: Emulsy P100 manufactured by RIKEN VITAMIN CO., LTD.) and 0.12 of lecithin were added thereto to prepare an oily phase. 1.0 parts of table salt was added to 16 parts of water to prepare an aqueous phase. 83 parts of the oily phase and 17 parts of the aqueous phase were mixed with each other and stirred at 60° C. to be preliminarily emulsified, and rapidly cooled and kneaded with a combinator to obtain a roll-in oil and fat composition 7 having a favorable structure. The rising melting point of the oily phase was 40.5° C.

Results of analyzing the oily phases of the roll-in oil and fat compositions prepared in Examples 1 to 3 and Comparative Examples 1 to 4 are shown in Table 2.

TABLE 2

| | | | | Comparative | Comparative | Comparative | Comparative |
|---|---|---|---|---|---|---|---|
| | Example 1 | Example 2 | Example 3 | Example 1 | Example 2 | Example 3 | Example 4 |
| Roll-in oils and | Composition 1 | Composition 2 | Composition 3 | Composition 4 | Composition 5 | Composition 6 | Composition 7 |
| fats | | | | | | | |
| Oils and fats 1 | 82 | | | | | 70 | 80 |
| (Trial Production | | | | | | | |
| Example 1) | | | | | | | |
| Oils and fats 2 | | 82 | | | | | |
| (Trial Production | | | | | | | |
| Example 2) | | | | | | | |
| Oils and fats 3 | | | 82 | | | | |
| (Trial Production | | | | | | | |
| Example 3) | | | | | | | |
| Oils and fats 4 | | | | 82 | | | |
| (Trial Production | | | | | | | |
| Example 4) | | | | | | | |
| Oils and fats 5 | | | | | 82 | | |
| (Trial Production | | | | | | | |
| Example 5) | | | | | | | |
| Oils and fats 6 | | | | | | 20 | |
| (Trial Production | | | | | | | |
| Example 6) | | | | | | | |
| Extremely | | | | | | | 2 |
| hardened high | | | | | | | |
| erucic acid | | | | | | | |
| rapeseed oil | | | | | | | |
| Rapeseed oil | 18 | 18 | 18 | 18 | 18 | 10 | 18 |
| Rising melting | 36.0 | 34.2 | 31.2 | 32.2 | 32.1 | 37.3 | 40.5 |
| point ° C. of oily | | | | | | | |
| phase | | | | | | | |
| SFC at 20° C. | 33.6 | 25.2 | 25.8 | 24.2 | 23.2 | 39.5 | 35.5 |
| SFC at 35° C. | 5.5 | 3.2 | 4.1 | 1.8 | 1.6 | 9.6 | 7.5 |

(Preparation of Layered Bakery Food)

Croissants were prepared with the following formulation using the roll-in oil and fat compositions 1 to 7 prepared in Examples 1 to 3 and Comparative Examples 1 to 4.

Formulation of Croissant Dough

Hard flour: 100 parts by weight

White superior soft sugar: 8 parts by weight

Table salt: 1.6 parts by weight

Powdered skim milk: 3 parts by weight

Whole egg: 10 parts by weight

Malt syrup: 0.5 parts by weight

Kneaded oils and fats: 6 parts by weight

Yeast: 3 parts by weight

Yeast food: 0.1 parts by weight

Water: 50 parts by weight

50 parts by weight of each roll-in oil and fat composition were used based on the hard flour.

### Examples 4 to 6 and Comparative Examples 5 to 8

The above-described croissant dough raw materials were kneaded and fermented in a chamber for 60 minutes at a humidity of 75% at 28° C., and were then retarded for 60 minutes in a freezer at −18° C. Each of the roll-in oil and fat compositions of Examples 5 to 8 and Comparative Examples 3 and 4 was folded (50% based on flour), and three-folding was performed twice with a reversible sheeter. Thereafter, the roll-in oil and fat compositions were retarded for 60 minutes in a freezer at −7° C., and three-folding was performed once with the reversible sheeter. Then, the roll-in oil and fat compositions were retarded for 45 minutes in the freezer at −7° C. Subsequently, the retarded dough was finally spread with the reversible sheeter to a thickness of 4 mm and molded. After the molding, the dough pieces were fermented in a chamber for 60 minutes at a humidity of 75% at 32° C., and were then baked in an oven for 16 minutes at a temperature of 210° C. in the chamber to obtain croissants 1 to 7.

(Evaluation of Chewy Texture and Spreadability of Roll-in Oil and Fat Composition)

Each of the roll-in oil and fat compositions of which the temperature was controlled in a constant temperature chamber at 10° C. and 20° C. was wrapped in dough and folded (50% based on flour), and three-folding was performed twice with a reversible sheeter. The spreadability of the roll-in oil and fat compositions was evaluated according to the following criteria. In addition, the chewy texture of the roll-in oil and fat compositions was evaluated according to the following criteria from the dough state during final spreading. The evaluation results are shown in Table 3. A score of O or higher was considered to be acceptable.

(Evaluation of Roll-in (Spreadability) When Temperature is Controlled at 10° C.)

⊚: A roll-in oil and fat composition cleanly extends to ends without any cracks.

◯: Although there is no crack in a roll-in oil and fat composition, dough remains at the end.

Δ: There are slight cracks in a roll-in oil and fat composition, and dough remains at the end.

x: Roll-in oils and fats are cracked and hardly extend.

(Evaluation of Roll-in (Spreadability) when Temperature is Controlled at 20° C.)

⊚: Roll-in oils and fats extend without any cracks and do not soften, and dough does not shrink.

◯: Roll-in oils and fats extend without any cracks, but slightly soften, and dough shrinks.

Δ: Roll-in oils and fats extend without any cracks, but soften, and dough shrinks.

x: Roll-in oils and fats soften and are kneaded into dough.

(Evaluation of Dough State (Chewy Texture) after Molding after Final Spreading)

⊚: Dough has a high chewy texture, does not shrink at all, and has good moldability.

O: Dough has a chewy texture, hardly shrinks, and has good moldability.

Δ: Dough is slightly soft and slightly shrinks, and therefore has inferior moldability.

x: Dough is soft and shrinks, and therefore has poor moldability.

(Evaluation of Layered Bakery Food)

A sensory evaluation by seven panelists was performed on the croissants 1 to 6 prepared above. Results of the evaluation of a melt-in-the-mouth feeling, a juicy feeling, and a texture (crispiness or a crunchy feeling) one day after being baked are shown in Table 3. A score of 0 or higher was considered to be acceptable.

(Melt-in-Mouth Feeling)

⊚: Extremely favorable

◯: Favorable

Δ: Slightly poor

x: Poor

(Juicy Feeling)

⊚: Extremely favorable

O: Favorable

Δ: Slightly poor

x: Poor

(Texture)

⊚: Crispiness and a crunchy feeling are extremely favorable.

◯: Crispiness and a crunchy feeling are favorable.

Δ: There is a slight lack of crispiness and a crunchy feeling.

Δ: There is a lack of crispiness and a crunchy feeling.

TABLE 3

| | | | | Comparative | Comparative | Comparative | Comparative |
|---|---|---|---|---|---|---|---|
| | Example 4 | Example 5 | Example 6 | Example 5 | Example 6 | Example 7 | Example 8 |
| Roll-in oils and | Composition 1 | Composition 2 | Composition 3 | Composition 4 | Composition 5 | Composition 6 | Composition 7 |
| fats | | | | | | | |
| Spreadability at | ◯ | ⊙ | ⊙ | Δ | Δ | ◯ | ⊙ |
| controlled | | | | | | | |
| temperature of | | | | | | | |
| 10° C. | | | | | | | |
| Spreadability at | ⊙ | ⊙ | ⊙ | X | X | ⊙ | ⊙ |
| controlled | | | | | | | |
| temperature of | | | | | | | |
| 20° C. | | | | | | | |
| Final spreading | ⊙ | ⊙ | ⊙ | X | X | ⊙ | ⊙ |
| and moldability | | | | | | | |
| Croissants | 1 | 2 | 3 | 4 | 5 | 6 | 7 |
| Melt-in- mouth | ⊙ | ⊙ | ⊙ | ⊙ | ⊙ | Δ | Δ |
| feeling | | | | | | | |
| Juicy feeling | ⊙ | ⊙ | ⊙ | ⊙ | ⊙ | X | X |
| Texture | ⊙ | ◯ | ◯ | Δ | Δ | ⊙ | ⊙ |

As shown in Table 3, Examples 1 to 3 in which an oil mixture of each of the transesterified oils and fats 1 to 3 of the present invention and rapeseed oil is used as an oily phase have favorable spreadability at 10° C. to 20° C. and an excellent chewy texture. In addition, Examples 4 to 6 baked using the roll-in oil and fat compositions 1 to 3 have favorable melt-in-the-mouth feeling, juicy feeling, crispiness, and crunchy feeling. Comparative Examples 1 and 2 in which an oil mixture of each of the transesterified oils and fats 4 and 5 having a low St/P ratio and rapeseed oil is used as an oily phase have favorable melt-in-the-mouth feeling and juicy feeling, but lack spreadability at 10° C. to 20° C. and have slightly poor crispiness of the croissants. Comparative Examples 3 and 4 in which the transesterified oils and fats 6 or extremely hardened high erucic acid rapeseed oil as high-melting-point oils and fats is formulated with an oil mixture of the transesterified oils and fats 1 of the present invention and rapeseed oil have favorable spreadability at 10° C. to 20° C. and favorable crispiness of the croissants, but have a slightly poor melt-in-the-mouth feeling and lack a juicy feeling.

### Example 7

Melted oils of 63 parts of the oils and fats 1 prepared in Trial Production Example 1, 5 parts of the oils and fats 4 prepared in Trial Production Example 4, 21 parts of rapeseed oil, and 11 parts of butter oil were mixed with each other, and 0.48 parts of stearic acid monoglyceride (trade name: Emulsy P-100 manufactured by RIKEN VITAMIN CO., LTD.) and 0.12 parts of lecithin were added thereto to prepare an oily phase. 1 part of table salt was added to 10 parts of water to prepare an aqueous phase. 89 parts of the oily phase and 11 parts of the aqueous phase were mixed with each other and stirred at 60° C. to be preliminarily emulsified, and rapidly cooled and kneaded with a combinator to obtain a roll-in oil and fat composition 8 having a favorable structure. The rising melting point of the oily phase was 35.7° C.

### Example 8

A roll-in oil and fat composition 9 was obtained in the same manner as in Example 7 by replacing 63 parts of the oils and fats 1 of Example 7 with 63 parts of the oils and fats 2 prepared in Trial Production Example 2. The rising melting point of the oily phase was 33.8° C.

### Example 9

A roll-in oil and fat composition 10 was obtained in the same manner as in Example 7 by replacing 63 parts of the oils and fats 1 of Example 7 with 63 parts of the oils and fats 3 prepared in Trial Production Example 3. The rising melting point of the oily phase was 30.3° C.

### Example 10

Melted oils of 50 parts of the oils and fats 1 prepared in Trial Production Example 1, 18 parts of the oils and fats 4 prepared in Trial Production Example 4, 21 parts of rapeseed oil, and 11 parts of butter oil were mixed with each other, and 0.48 parts of stearic acid monoglyceride (trade name: Emulsy P100 manufactured by RIKEN VITAMIN CO., LTD.) and 0.12 parts of lecithin were added thereto to prepare an oily phase. 1 part of table salt was added to 10 parts of water to prepare an aqueous phase. 89 parts of the oily phase and 11 parts of the aqueous phase were mixed with each other and stirred at 60° C. to be preliminarily emulsified, and rapidly cooled and kneaded with a combinator to obtain a roll-in oil and fat composition 11 having a favorable structure. The rising melting point of the oily phase was 34.8° C.

### Comparative Example 9

Melted oils of 40 parts of the oils and fats 1 prepared in Trial Production Example 1, 28 parts of the oils and fats 4 prepared in Trial Production Example 4, 21 parts of rapeseed oil, and 11 parts of butter oil were mixed with each other, and 0.48 parts of stearic acid monoglyceride (trade name: Emulsy P100 manufactured by RIKEN VITAMIN CO., LTD.) and 0.12 parts of lecithin were added thereto to prepare an oily phase. 1 part of table salt was added to 10 parts of water to prepare an aqueous phase. 89 parts of the oily phase and 11 parts of the aqueous phase were mixed with each other and stirred at 60° C. to be preliminarily emulsified, and rapidly cooled and kneaded with a combinator to obtain a roll-in oil and fat composition 12 having a favorable structure. The rising melting point of the oily phase was 34.2° C.

### Comparative Example 10

Melted oils of 30 parts of the oils and fats 1 prepared in Trial Production Example 1, 38 parts of the oils and fats 4 prepared in Trial Production Example 4, 21 parts of rapeseed oil, and 11 parts of butter oil were mixed with each other, and 0.48 parts of stearic acid monoglyceride (trade name: Emulsy P100 manufactured by RIKEN VITAMIN CO., LTD.) and 0.12 parts of lecithin were added thereto to prepare an oily phase. 1 part of table salt was added to 10 parts of water to prepare an aqueous phase. 89 parts of the oily phase and 11 parts of the aqueous phase were mixed with each other and stirred at 60° C. to be preliminarily emulsified, and rapidly cooled and kneaded with a combinator to obtain a roll-in oil and fat composition 13 having a favorable structure. The rising melting point of the oily phase was 33.8° C.

### Comparative Example 11

Melted oils of 23 parts of the oils and fats 1 prepared in Trial Production Example 1, 35 parts of the oils and fats 4 prepared in Trial Production Example 4, 7 parts of the oils and fats 6 prepared in Trial Production Example 6, 15 parts of rapeseed oil, and 20 parts of butter oil were mixed with each other, and 0.48 parts of stearic acid monoglyceride (trade name: Emulsy P100 manufactured by RIKEN VITAMIN CO., LTD.) and 0.12 parts of lecithin were added thereto to prepare an oily phase. 1 part of table salt was added to 10 parts of water to prepare an aqueous phase. 89 parts of the oily phase and 11 parts of the aqueous phase were mixed with each other and stirred at 60° C. to be preliminarily emulsified, and rapidly cooled and kneaded with a combinator to obtain a roll-in oil and fat composition 14 having a favorable structure. The rising melting point of the oily phase was 33.9° C.

Results of analyzing the oily phases of the roll-in oil and fat compositions prepared in Example 13 and Comparative Example 7 are shown in Table 4.

TABLE 4

| | | | | | Comparative | Comparative | Comparative |
|---|---|---|---|---|---|---|---|
| | Example 7 | Example 8 | Example 9 | Example 10 | Example 9 | Example 10 | Example 11 |
| Roll-in oils and | Composition 8 | Composition 9 | Composition 10 | Composition 11 | Composition 12 | Composition 13 | Composition 14 |
| fats | | | | | | | |
| Oils and fats 1 | 63 | | | 50 | 40 | 30 | 23 |
| (Trial Production | | | | | | | |
| Example 1) | | | | | | | |
| Oils and fats 2 | | 63 | | | | | |
| (Trial Production | | | | | | | |
| Example 2) | | | | | | | |
| Oils and fats 3 | | | 63 | | | | |
| (Trial Production | | | | | | | |
| Example 3) | | | | | | | |
| Oils and fats 4 | 5 | 5 | 5 | 18 | 28 | 38 | 35 |
| (Trial Production | | | | | | | |
| Example 4) | | | | | | | |
| Oils and fats 6 | | | | | | | 7 |
| (Trial Production | | | | | | | |
| Example 6) | | | | | | | |
| Rapeseed oil | 21 | 21 | 21 | 21 | 21 | 21 | 15 |
| Butter oil | 11 | 11 | 11 | 11 | 11 | 11 | 20 |
| Rising melting | 35.7 | 33.8 | 30.3 | 34.8 | 34.2 | 33.8 | 33.9 |
| point ° C. of oily | | | | | | | |
| phase | | | | | | | |
| SFC at 20° C. | 28.3 | 24.2 | 24.4 | 27.2 | 26.2 | 25.7 | 28.9 |
| SFC at 35° C. | 3.6 | 2.4 | 3.7 | 3.2 | 3.0 | 2.8 | 2.9 |

### Examples 11 to 14 and Comparative Examples 12 to 14

Croissants were prepared in the same manner as in Examples 4 to 6 using the roll-in oil and fat compositions 8 to 14 prepared in Examples 11 to 14 and Comparative Examples 12 to 14 to obtain croissants 8 to 14. Evaluation of a chewy texture and spreadability of the roll-in oil and fat compositions 8 to 14 was performed in the same manner as in Examples 4 to 6 under the conditions of 10° C. and 20° C., and evaluation of the croissants 8 to 14 was performed in the same manner as in Examples 4 to 6. The results are shown in Table 5.

TABLE 5

| | | | | | Comparative | Comparative | Comparative |
|---|---|---|---|---|---|---|---|
| | Example 11 | Example 12 | Example 13 | Example 14 | Example 12 | Example 13 | Example 14 |
| Roll-in oils and | Composition 8 | Composition 9 | Composition 10 | Composition 11 | Composition 12 | Composition 13 | Composition 14 |
| fats | | | | | | | |
| Spreadability at | ⊙ | ⊙ | ⊙ | ⊙ | Δ | Δ | O |
| controlled | | | | | | | |
| temperature of | | | | | | | |
| 10° C. | | | | | | | |
| Spreadability at | ⊙ | ◯ | ◯ | ◯ | Δ | X | Δ |
| controlled | | | | | | | |
| temperature of | | | | | | | |
| 20° C. | | | | | | | |
| Final spreading | ⊙ | ◯ | ◯ | ◯ | Δ | X | Δ |
| and moldability | | | | | | | |
| Croissants | 8 | 9 | 10 | 11 | 12 | 13 | 14 |
| Melt-in- mouth | ⊙ | ⊙ | ⊙ | ⊙ | ⊙ | ⊙ | Δ |
| feeling | | | | | | | |
| Juicy feeling | ⊙ | ⊙ | ⊙ | ◯ | ◯ | ◯ | X |
| Texture | ⊙ | ◯ | ◯ | ◯ | Δ | Δ | ◯ |

As shown in Table 5, Examples 7 to 10 in which 55 to 63% by weight of the transesterified oils and fats of the present invention and 11% by weight of rapeseed oil were formulated in an oily phase have favorable spreadability at 10° C. to 20° C. and an excellent chewy texture. In addition, Examples 11 to 14 baked using the roll-in oil and fat compositions of Examples 7 to 10 have favorable melt-in-the-mouth feeling, juicy feeling, crispiness, and crunchy feeling. Comparative Examples 9 and 10 in which the transesterified oils and fats of the present invention in the oily phase are 30 to 40% by weight have favorable melt-in-the-mouth feeling and juicy feeling, but lack spreadability at 10° C. to 20° C. and have slightly poor crispiness of the croissants. Comparative Example 11 in which the transesterified oils and fats 6 as high-melting-point oils and fats is formulated with an oil mixture of the transesterified oils and fats 1 of the present invention, the transesterified oils and fats 4 prepared in Trial Production Example 4, and rapeseed oil have favorable spreadability at 10° C. to 20° C., and the croissant of Comparative Example 14 baked using the same has favorable crispiness. However, the croissant has a slightly poor melt-in-the-mouth feeling and lacks a juicy feeling.

### INDUSTRIAL APPLICABILITY

According to the present invention, it is possible to provide: a roll-in oil and fat composition which is of a low-trans type with a trans fatty acid content of less than 5% by weight, has a high chewy texture, has excellent spreadability in a wide temperature range, and has an excellent melt-in-the-mouth feeling; and layered bakery food which can be produced using the roll-in oil and fat composition and has substantially a fresh-baked juicy texture and crispiness even one day after being baked.

1. A roll-in oil and fat composition comprising:
45 to 95% by weight of transesterified oils and fats, 5 to 25% by weight of a liquid oil, and less than 1% by weight of high-melting-point oils and fats in an oily phase,
wherein the transesterified oils and fats have a lauric acid content of 5 to 25% by weight, a palmitic acid content of 5 to 25% by weight, and a stearic acid content of 10 to 35% by weight all relative to the total content of all of constituent fatty acids and have a stearic acid-to-palmitic acid weight ratio of 0.5 to 7, and
wherein the high-melting-point oils and fats have a rising melting point of higher than 45° C.

2. The roll-in oil and fat composition according to claim 1,
wherein high-melting-point oils and fats having a rising melting point of higher than 45° C. are not contained in the oily phase.

3. The roll-in oil and fat composition according to claim 1,
wherein the oils and fats in the oily phase have a rising melting point of 30° C. to 40° C., an SFC of 20% to 45% at 20° C., and an SFC of less than or equal to 10% at 35° C.

4. The roll-in oil and fat composition according to claim 2,
wherein the oils and fats in the oily phase have a rising melting point of 30° C. to 40° C., an SFC of 20% to 45% at 20° C., and an SFC of less than or equal to 10% at 35° C.

5. The roll-in oil and fat composition according to claim 1,
wherein a fat and oil content is 50 to 100% by weight.

6. The roll-in oil and fat composition according to claim 2,
wherein a fat and oil content is 50 to 100% by weight.

7. The roll-in oil and fat composition according to claim 3,
wherein a fat and oil content is 50 to 100% by weight.

8. The roll-in oil and fat composition according to claim 4,
wherein a fat and oil content is 50 to 100% by weight.

9. Layered bakery food using the roll-in oil and fat composition according to claim 5.

10. Layered bakery food using the roll-in oil and fat composition according to claim 6.

11. Layered bakery food using the roll-in oil and fat composition according to claim 7.

12. Layered bakery food using the roll-in oil and fat composition according to claim 8.
